(19) United States
(12) Patent Application Publication
(10) Pub. No.: US 2021/0243998 A1
(43) Pub. Date: Aug. 12, 2021

(54) SUPPORTING DEVICE FOR TRIMMING CLAWS OF COMPANION ANIMAL

(71) Applicant: BORA LEE, Gwangju (KR)

(72) Inventor: BORA LEE, Gwangju (KR)

(21) Appl. No.: 16/981,286

(22) PCT Filed: Aug. 18, 2020
(86) PCT No.: PCT/KR2020/010956

§ 371 Date: Sep. 16, 2020

(30) Foreign Application Priority Data
Dec. 6, 2019 (KR) 10-2019-0161915

(51) Int. Cl. A01K 13/00

(52) U.S. Cl. CPC A01K 13/00

(57) ABSTRACT

A supporting device includes: a finger receiving part having a finger receiving hole into which a user's finger is inserted; and a claw trimming part connected to one side of the finger receiving part, and configured to expose a companion animal's claw by blocking fur of the claw. The supporting device for trimming claws of a companion animal is configured to expose only the claw by the claw trimming part provided at the one side of the finger receiving part with the finger receiving hole in which the finger is inserted, so that the user holds a companion animal's paw by hand and safely and conveniently trims the claw.

### TECHNICAL FIELD

The present disclosure relates to a supporting device for trimming claws of a companion animal. More particularly, the present disclosure relates to a supporting device for trimming claws of a companion animal, the supporting device being configured to expose only claws by a claw trimming part, so that it is possible to safely and conveniently trim the claws by holding a companion animal's paw by hand.

### BACKGROUND ART

In general, companion animals such as dogs and cats have sharp claws, which may cause unexpected scratches and other injuries.

Due to the habit of companion animals scratching with claws, when the claws are sharp, furniture or the floor may be damaged with scratches. Therefore, it is necessary to periodically trim the claws of the companion animals.

As the related art, a claw clipper for a companion animal is disclosed. The claw clipper includes a pair of upper and lower plates, wherein rear ends thereof are coupled to each other and front ends thereof remain open by elastic force and the front ends have sharp trimming portions for trimming the claws. The claw clipper of the related art is configured of a fixing pin rotatably and horizontally inserted in holes perforated at the front ends of the upper and lower plates and the claw clipper being configured of a push lever fitted in a groove provided at an upper end of the fixing pin to serve as a lever.

The claw-trimming operation using the claw clipper of the related art proceeds as follows. A user inserts a companion animal's claw between the upper and lower plates of the claw clipper. When the user presses the push lever, the upper and lower plates are closed together, and the claw of the length inserted in the upper and lower plates is trimmed by the trimming portions of the upper and lower plates. When the external force is removed from the push lever, the upper and lower plates are opened to their original positions.

However, in the claw clipper of the related art, when the companion animal's claw is trimmed, the user should arbitrarily insert the claw between the trimming portions, so it is difficult to precisely trim the claw. In the process of trimming the claw, a nerve in the claw may be cut due to the movement of the user or the companion animal, and thus, the companion animal may be injured and bleed.

The claw of the companion animal has a round shape rather than a flat shape like humans. Therefore, in a method of trimming the claw by the facing trimming portions, two opposite blades of the facing trimming portions press and trim the claw, so that the claw may be forcibly crushed and damaged.

As a related art, in Korean patent No. 10-2005844 (registered July 25, 2019) “CLAW CARE ASSIST DEVICE FOR A PET” registered by the applicant of the present disclosure, the device includes a cover plate having a plurality of claw exposing holes spaced apart from each other at a predetermined distance, and a band part extended from one side of the cover plate toward opposite directions and having a fastening means for covering and fixing the companion animal's paw.

However, the claw clipper of the related art has a problem that a gap is generated between the companion animal's toes when claws are inserted into the claw exposing holes. Further, when the user trims the claw while covering the companion animal's paw by the fastening means, the companion animal's paw may deviate from the user's hand, and suddenly scratch the user.

### DISCLOSURE

### Technical Problem

Accordingly, the present disclosure has been made keeping in mind the above problems occurring in the related art, and an objective of the present disclosure is to provide a new-structure supporting device for trimming claws of a companion animal. The supporting device is configured to expose only claws of companion animal by a claw trimming part, so that a user trims the claws safely and conveniently by holding a companion animal's paw by hand.

Another objective of the present disclosure is to provide a supporting device for trimming claws of a companion animal. Wherein at least one finger receiving part is provided in the supporting device and is stretched in one direction. Whereby, the supporting device is used while being adjusted in length by stretching the finger receiving part, so that an upper portion of an end of the companion animal's toe with a different size is covered by the finger receiving part while a user's finger is inserted in a first finger receiving hole.

A further objective of the present disclosure is to provide a supporting device for trimming claws of a companion animal. Wherein a connection part is provided to increase the length of the supporting device, so that the claw of a big companion animal, which is difficult to be covered only by stretching the finger receiving part, is trimmed.

A further objective of the present disclosure is to provide a supporting device for trimming claws of a companion animal. Wherein an extension part is provided at the first finger receiving hole to enlarge a size of the finger receiving hole as the finger receiving hole is enlarged by physical force in response to thickness of the user's finger, so that a user having thick fingers can easily use the supporting device.

### Technical Solution

In order to accomplish the above object, the present disclosure provides a supporting device for trimming claws of a companion animal. The supporting device for trimming claws of a companion animal includes: a finger receiving part having a finger receiving hole into which a user's finger is inserted; and a claw trimming part connected to one side of the finger receiving part, and configured to expose only a companion animal's claw by blocking fur of the claw.

### Advantageous Effects

As described above, the supporting device for trimming claws of a companion animal according to the present disclosure is configured to expose only a companion animal's claw by the claw trimming part provided at one side of the finger receiving part with the finger receiving hole in which the user's finger is inserted. Accordingly, the user can hold the companion animal's paw by hand and safely and conveniently trim the claw.

The supporting device for trimming claws of a companion animal according to the present disclosure has at least one finger receiving part that stretches in one direction. Accordingly, while the user's finger is inserted in the first finger receiving hole, the supporting device can be adjusted in length by enlarging the finger receiving part so as to cover an upper portion of an end of the companion animal's toe that has various sizes.

The supporting device for trimming claws of a companion animal of the present disclosure has the finger receiving part in which inner diameter consists of a long axis and a short axis. Accordingly, when the user's finger is inserted into the finger receiving hole, the finger receiving part presses and is brought into close contact with the finger, so that it is possible to prevent the user's finger from falling out of the finger receiving hole.

The supporting device for trimming claws of a companion animal according to the present disclosure is configured such that, when the user holds the companion animal's paw, the user's hand is positioned at a first side of the supporting device and the companion animal's claw is positioned at a second side thereof. Accordingly, by giving the companion animal a sense of psychological stability without stress, the user can easily trim the claw.

The supporting device for trimming claws of a companion animal according to the present disclosure includes the first finger receiving hole having the extension part. Accordingly, a size of the finger receiving hole is enlarged by the physical force in response to the thickness of the user's finger, so that the user having a thick finger can easily use the supporting device.

### DESCRIPTION OF DRAWINGS

FIG. 1 is a perspective view schematically showing an external appearance of a supporting device for trimming claws of a companion animal according to an first embodiment of the present disclosure;

FIGS. 2 and 3 are exemplary views showing states of using the supporting device for trimming claws of a companion animal according to the first embodiment of the present disclosure;

FIG. 4 is a perspective view schematically showing an external appearance of a supporting device for trimming claws of a companion animal according to a second embodiment of the present disclosure;

FIG. 5 is a perspective view showing the supporting device for trimming claws of a companion animal in FIG. 4, wherein a finger receiving part thereof has a supporting part;

FIG. 6 is a section view showing a state in which the supporting part in FIG. 5 supports a user's finger;

FIG. 7 is a perspective view schematically showing an external appearance of a supporting device for trimming claws of a companion animal according to a third embodiment of the present disclosure;

FIG. 8 is a view showing a supporting device for trimming claws of a companion animal according to a fourth embodiment of the present disclosure; and

FIG. 9 is a view from a lower surface showing the supporting device for trimming claws of a companion animal according to the fourth embodiment of the present disclosure.

### BEST MODE

In order to solve the above problems, the present disclosure provides a supporting device for trimming claws of a companion animal, the supporting device including: a finger receiving part having a finger receiving hole into which a user's finger is inserted; and a claw trimming part connected to one side of the finger receiving part, and configured to expose only a companion animal's claw by blocking fur of the claw.

The finger receiving part includes at least one finger receiving part, and is configured to stretch in one direction and to cover an upper end of a companion animal's toe.

The claw trimming part has a body plate and a main exposing hole, the body plate having a plate shape for pushing the fur of the companion animal's claw and the main exposing hole being provided by perforating one surface of the body plate, so that the claw is exposed through the main exposing hole.

The claw trimming part has an auxiliary exposing hole at one side of the main exposing hole, the auxiliary exposing hole having a size different from a size of the main exposing hole.

Further, the supporting device includes a connection part provided between the finger receiving hole and an adjacent finger receiving hole.

Further, the supporting device includes a supporting part having a taper shape tapering from an edge of the finger receiving hole toward a center of a circle, and the supporting part is formed of an elastic material and presses the finger inserted in the finger receiving hole.

The finger receiving part having an extension part, the extension part being configured as a groove at one side of the finger receiving part and being configured to enlarge a size of the finger receiving hole as the groove is enlarged by physical force in response to thickness of the user's finger.

### MODE FOR INVENTION

Hereinbelow, exemplary embodiments of the present disclosure will be described in detail with reference to the accompanying drawings such that the present disclosure can be easily embodied by one of ordinary skill in the art to which this present disclosure belongs. Further, in describing the operation principle of the exemplary embodiments of the present disclosure, if it is decided that the detailed description of known function or configuration related to the present disclosure makes the subject matter of the present disclosure unclear, the detailed description is omitted.

The same reference numerals are used throughout the different drawings to designate the same or similar components.

In addition, through the specification, it will be understood that when a portion is referred to as being “connected” or “coupled” to another portion, it may be directly connected or coupled to the other portion, or intervening portions may be present therebetween. Unless the context clearly indicates otherwise, it will be further understood that the terms “comprises”, “comprising”, “includes”, when used herein, specify the presence of stated features, integers, steps, operations, elements, and/or components, but do not preclude the presence or addition of one or more other features, integers, steps, operations, elements, components, and/or groups thereof.

The terms “first finger receiving hole” and “nth finger receiving hole” that are used herein may be used to distinguish at least one finger receiving hole, but the present disclosure should not be limited to these terms.

Hereinbelow, a supporting device for trimming claws of a companion animal according to the exemplary embodiments of the present disclosure will be described in detail with reference to the accompanying drawings.

### First Embodiment

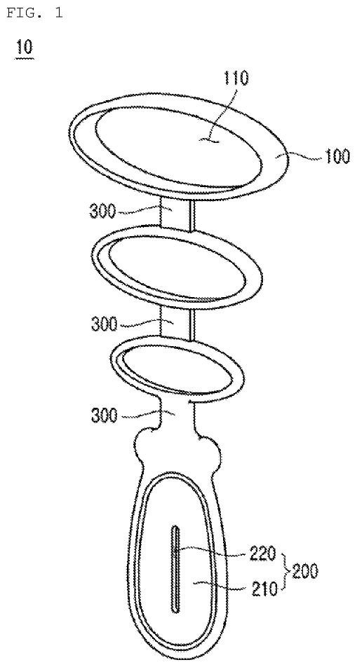

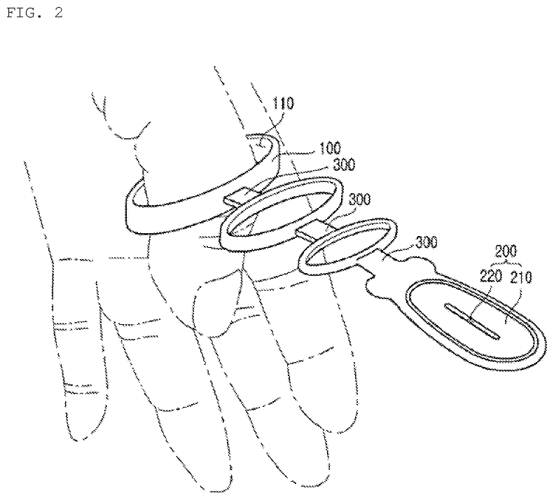

FIG. 1 is a perspective view schematically showing an external appearance of a supporting device for trimming claws of a companion animal according to a first embodiment of the present disclosure. FIGS. 2 and 3 are exemplary views showing states of using the supporting device for trimming claws of a companion animal according to the first embodiment of the present disclosure.

As shown in FIGS. 1 and 2, the supporting device for trimming claws of a companion animal 10 according to the first embodiment of the present disclosure may include a finger receiving part 100 and a claw trimming part 200.

As shown in FIGS. 1 to 3, according to the first embodiment of the present disclosure, the supporting device for trimming claws of a companion animal 10 may include the finger receiving part 100 and the claw trimming part 200, the finger receiving part 100 having a finger receiving hole 110 into which a user's finger is inserted, and the claw trimming part 200 being connected to one side of the finger receiving part 100 and blocking fur of the companion animal's claw to expose only the claw.

The finger receiving part 100 may have the finger receiving hole 110 into which the user's finger is inserted. Therefore, the finger receiving part may hold the companion animal by covering the companion animal with the finger inserted in the finger receiving hole 110.

The finger receiving part 100 may be formed of any one material selected from a group consisting of silicone, rubber, or soft synthetic resin.

Further, the finger receiving part 100 may include at least one receiving part, and may be configured to stretch in one direction and to cover an upper portion of an end of the companion animal's toe. Herein, when necessary, the user can cover a lower portion of the end of the companion animal's toe by using the finger receiving part 100 to trim the claws of the companion animal.

For example, the finger receiving part 100 may be adjusted in length by pulling and stretching a second finger receiving hole or an nth finger receiving hole in one direction. That is, the length of the finger receiving part 100 may be increased by deforming the finger receiving hole 110 such that a long axis and a short axis thereof may be changed to each other.

Therefore, the user can hold a paw of a big companion animal and trim the claw thereof, thereby increasing the user's convenience.

Further, the finger receiving part 100 may be formed in an oval shape having a short axis and a long axis. Therefore, when the finger is inserted into the finger receiving hole 110, the finger receiving hole 110 may be may be brought into close contact with the user's finger along the short axis. When the user inserts a finger of the user's one hand into the finger receiving hole 110 for trimming the companion animal's claw, while the finger receiving hole 110 is stretched in the long axis, the finger receiving hole 110 may press and be brought into close contact with the user's finger along the short axis.

As a result, the user's finger may be prevented from falling out of the finger receiving hole 110, so that the user can stably hold the paw of the companion animal.

In the embodiment, the finger receiving part 100 is shown in an oval shape, but is not limited thereto, and may be folioed in circular, oval, triangular, rectangular, and rhombic shapes.

Referring to FIGS. 2 and 3, the claw trimming part 200 may be connected to one side of the finger receiving part 100 and may serve to expose only the claw by blocking fur of the claw of the companion animal.

That is, the claw trimming part 200 may include a body plate 210 and a main exposing hole 220, the body plate 210 having a plate shape for blocking the fur of the companion animal's claw and the main exposing hole 220 being formed by perforating one surface of the body plate 210. The claw of the companion animal may be exposed through the main exposing hole 220.

The claw trimming part 200 may exclude the fur grown at the toe's end of the companion animal so that the fur may be prevented from hiding the claw and interfering with claw trimming. Therefore, the user can conveniently trim the claw.

Meanwhile, as shown in FIG. 1, according to the first embodiment of the present disclosure, the supporting device for trimming claws of a companion animal 10 may include a connection part 300.

The connection part 300 may be formed in a band integrally connecting an outer circumferential surface of the first finger receiving hole 110 to an outer circumferential surface of the second finger receiving hole 110, which is positioned close to the first finger receiving hole 110. Accordingly, the connection part 300 may allow the second finger receiving hole to an nth finger receiving hole to be further stretched than when only the finger receiving holes are stretched in one direction to be adjusted in length.

In the embodiment, the connection part 300 is formed in a plate shape, but is not limited thereof, and may be formed in either one of zigzag, bellows, and elastic band shapes. As long as the length is stretchable, the connection part 300 may not be limited to the above-described shapes.

Hereinbelow, through each configuration, the process of using the supporting device for trimming claws of a companion animal will be described.

Referring to FIGS. 2 and 3, the user inserts a thumb into the finger receiving hole 110. Then, the user holds the companion animal's paw by the hand which has the thumb inserted into the finger receiving hole 110.

Then, the user holds the body plate 210, which is positioned at one side of the finger receiving part 100 and constitutes the claw trimming part 200, with the other hand which does not have the thumb inserted in the finger receiving hole 110, and places the body plate 210 at the companion animal's claw to be trimmed.

Herein, the user pushes the body plate 210 with the other hand, so that the claw is inserted into the main exposing hole 220.

Then, the user further pushes the body plate 210 with the other hand, so that the claw's fur is blocked by the body plate 210 and the claw of the companion animal protrudes through the main exposing hole 220.

Then, the user trims the claw by using a trimming device for a companion animal, with the other hand, and after the trimming is completed, the user trims other claws of the companion animal in order.

### Second Embodiment

In the supporting device for trimming claws of a companion animal according to a second embodiment of the present disclosure, components that are the same or similar to those of the first embodiment are given the same reference numerals, and the redundant descriptions thereof are omitted. The modified components, an auxiliary exposing hole 400, will be described in detail.

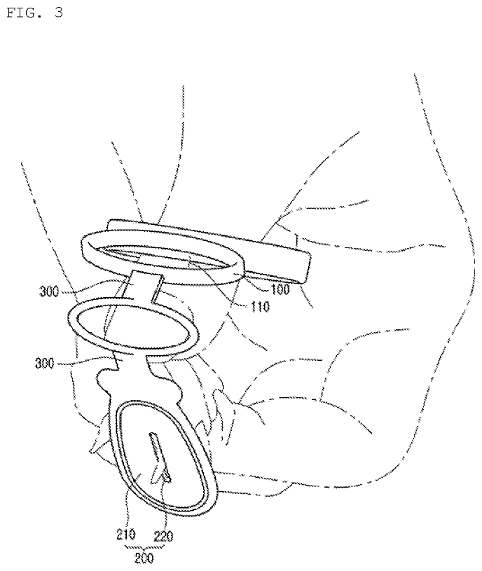

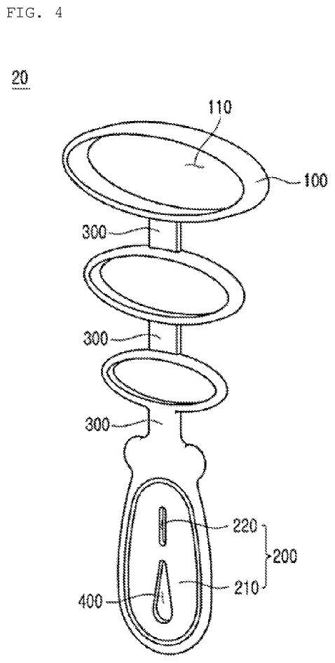

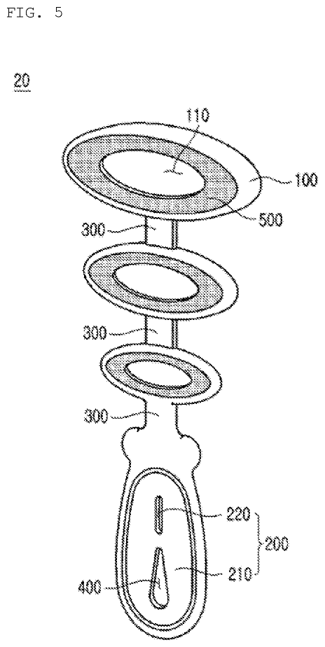

FIG. 4 is a perspective view schematically showing an external appearance of a supporting device for trimming claws of a companion animal according to the second embodiment of the present disclosure. FIG. 5 is a perspective view showing the supporting device for trimming claws of a companion animal in FIG. 4, wherein a finger receiving part thereof has a supporting part. FIG. 6 is a section view showing a state in which the supporting part in FIG. 5 supports the user's finger.

As shown in FIG. 4, according to the second embodiment of the present disclosure, the supporting device for trimming claws of a companion animal 20 may include: the finger receiving part 100 having the finger receiving hole 110 into which the user's finger is inserted; the claw trimming part 200 connected to one side of the finger receiving part 100 and having the body plate 210 and the main exposing hole 220, the body plate 210 blocking the fur of the companion animal's claw and the main exposing hole 220 being formed by perforating one surface of the body plate 210 to expose the claw therethrough; and the auxiliary exposing hole 400 having a size different from a size of the main exposing hole 220.

Referring to FIG. 4, the auxiliary exposing hole 400 may be provided at one side of the main exposing hole 220 that is formed by perforating one surface of the body plate 210, and the auxiliary exposing hole 400 may have the size different from the size of the main exposing hole 220.

The auxiliary exposing hole 400 may be formed larger or smaller than the main exposing hole 220, and serve to allow the user to select a size in response to a size of the companion animal's claw.

In particular, when the companion animal's body is large, it is common for the companion animal's claw to be large. Since the companion animal's claws are formed in a round shape, the claw protrudes in a longitudinal direction when protruding through the body plate 210, so a shape of the hole may be formed long in one direction.

Meanwhile, according to the second embodiment of the present disclosure, the supporting device for trimming claws of a companion animal 20 may include a supporting part 500, as shown in FIGS. 5 and 6.

The supporting part 500 may be foamed in a taper shape tapering from an edge of the finger receiving hole 110 toward a center of a circle.

The supporting part 500 may be formed of an elastic material and be configured to press the user's finger inserted in the finger receiving hole 110.

When the user inserts the finger into the finger receiving hole 110, the supporting part 500 may be positioned close to a nail portion of the finger. A first side of the finger receiving hole 110 may be positioned at a starting portion of the finger, and a second side of the finger receiving hole 110 may be positioned at a portion close to the nail of the finger, and the supporting part 500 may be positioned at the second side thereof.

The supporting part 500 may support the second side of the finger receiving hole 110 in which the finger is inserted, so that the finger may be prevented from falling out of the finger receiving part 100.

The supporting part 500 is provided in the second embodiment of the present disclosure, and may also be provided in the above-described first embodiment and a third embodiment.

### Third Embodiment

In the supporting device for trimming claws of a companion animal according to the third embodiment of the present disclosure, components that are the same or similar to those of the first embodiment refer to the above descriptions, and modified components, an extension part 600, and an exposing hole 220′, will be described in detail.

Further, the detailed descriptions of the components that are the same as or correspond to those of the first embodiment will be omitted below.

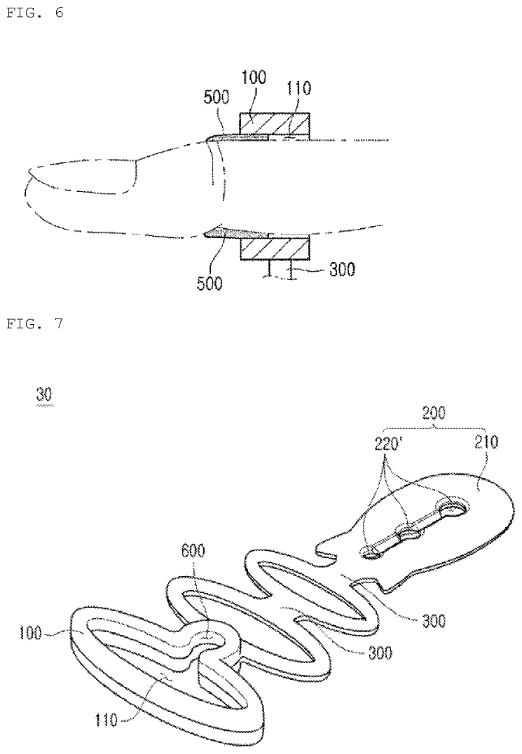

FIG. 7 is a perspective view schematically showing an external appearance of the supporting device for trimming claws of a companion animal according to the third embodiment of the present disclosure.

As shown in FIG. 7, according to the third embodiment of the present disclosure, the supporting device for trimming claws of a companion animal 30 may include: the finger receiving part 100 having the finger receiving hole 110 into which the user's finger is inserted; the claw trimming part 200 connected to one side of the finger receiving part 100 and having the body plate 210 and at least one exposing hole 220′, the body plate 210 blocking the fur of the companion animal's claw and the exposing hole 220′ being provided at one surface of the body plate 210 and exposing only the claw; and the extension part 600 configured as a groove at one side of the finger receiving part 100, and being configured to enlarge a size of the finger receiving hole as the groove is enlarged by physical force corresponding to thickness of the user's finger.

The extension part 600 may be configured as the groove such that one side of an edge of the first finger receiving hole protrudes in one direction.

The above structure may be provided to allow a user having a relatively thick finger to use the supporting device for trimming claws of a companion animal 30, when the user with different finger thickness inserts a finger into the finger receiving hole 110 for trimming the companion animal's claw.

The extension part 600 is provided in the first finger receiving hole to enlarge a size of the first finger receiving hole by the physical force corresponding to the thickness of the finger, so that the user having a relatively thick finger can easily use the supporting device for trimming the claws of a companion animal 30.

Meanwhile, at least one exposing hole 220′ may be formed on one surface of the body plate 210 to expose the claw in response to the position of the toe.

The exposing hole 220′ may be configured such that a groove is provided by perforating one surface of the body plate 210 and holes with different diameters are formed in the groove in a longitudinal direction of the groove.

Accordingly, the user can conveniently insert the claw into the exposing hole 220′ without the need to precisely adjust a position of the body plate 210 in order to trim the claws of various types of companion animals.

### Fourth Embodiment

In a supporting device for trimming claws of a companion animal according to a fourth embodiment of the present disclosure, components that are the same or similar to those of the third embodiment are given the same reference numerals, and the redundant descriptions thereof are omitted.

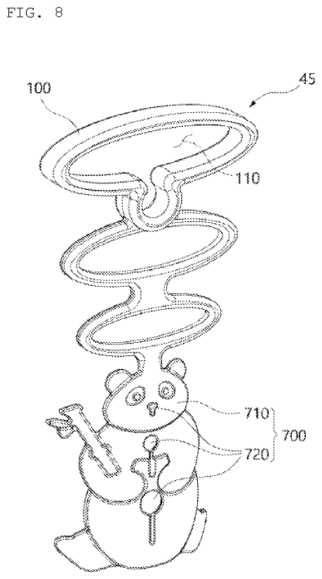

FIG. 8 is a perspective view schematically showing an external appearance of the supporting device for trimming claws of a companion animal according to the fourth embodiment of the present disclosure.

As shown in FIG. 8, according to the fourth embodiment of the present disclosure, the supporting device for trimming claws of a companion animal 40 may have a claw trimming part 700 with a different configuration from that of the claw trimming part of the third embodiment.

The claw trimming part 700 may include a body plate 710 blocking the fur of the companion animal's claw, and at least one exposing hole 720 provided in one surface of the body plate 710 to expose only the claw.

The body plate 710 may be formed in a plate shape of a design of a panda. In the fourth embodiment, the body plate 710 is designed in a panda, but is not necessarily limited thereto, and may be formed in various character design shapes including animal characters such as a fox, a bear, a mouse, etc.

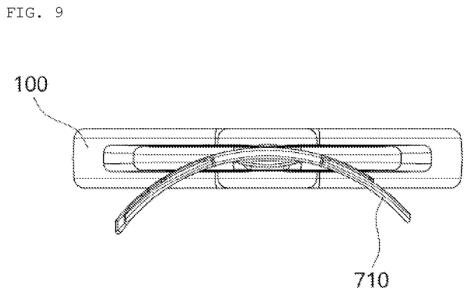

In the fourth embodiment, the body plate 710 may be preferably formed to be gently curved in a width direction of the body plate 710, as shown in FIG. 9.

By forming the body plate 710 in a gently arc shape, when the user inserts the companion animal's claw into the exposing hole 720 and trims the companion animal's claw, opposite sides of the gently curved body plate 710 in the width direction thereof may cover the companion animal's toe.

When the body plate 710 is formed in a flat plate shape, during the claw trimming, the claw to be trimmed may fall out of the claw trimming part as the claw trimming part interferes with an adjacent toe. However, in the case of the body plate 710 curved in the arc shape, during the claw trimming, the claw trimming part 700 may not be bought into contact or collide with the adjacent toe, and even when the claw trimming part 700 collides with the adjacent toe, the curved structure of the body plate 710 may prevent the claw from falling out of the claw trimming part 700.

The scope of the present disclosure is not limited to the above-described embodiments, but may be embodied in various embodiments within the accompanying claims, those skilled in the art will appreciate that various modifications, additions and substitutions are possible, without departing from the scope and spirit of the invention as disclosed in the accompanying claims.

1. A supporting device for trimming claws of a companion animal, the supporting device comprising:
a finger receiving part having a finger receiving hole into which a user's finger is inserted; and
a claw trimming part connected to one side of the finger receiving part, and configured to expose a companion animal's claw by blocking fur of the claw.

2. The supporting device of claim 1, wherein the finger receiving part comprises at least one finger receiving part, and is configured to stretch in one direction and to cover an upper end of a companion animal's toe.

3. The supporting device of claim 1, wherein the finger receiving part has a long axis and a short axis, and when the user's finger is inserted into the finger receiving hole, the finger receiving hole is configured to be brought into close contact with the user's finger along the short axis.

4. The supporting device of claim 1, wherein the claw trimming part has a body plate and a main exposing hole, the body plate having a plate shape for pushing the fur of the companion animal's claw and the main exposing hole being provided by perforating one surface of the body plate, so that the claw is exposed through the main exposing hole.

5. The supporting device of claim 4, wherein the claw trimming part has an auxiliary exposing hole at one side of the main exposing hole, the auxiliary exposing hole having a size different from a size of the main exposing hole.

6. The supporting device of claims 1, further comprising:
a connection part provided between the finger receiving hole and an adjacent finger receiving hole.

7. The supporting device of claims 1, further comprising:
a supporting part having a taper shape tapering from an edge of the finger receiving hole toward a center of a circle,
wherein the supporting part is formed of an elastic material and presses the finger inserted in the finger receiving hole.

8. The supporting device of claim 4, wherein the finger receiving part having an extension part, the extension part being configured as a groove at one side of the finger receiving part and being configured to enlarge a size of the finger receiving hole as the groove is enlarged by physical force in response to thickness of the user's finger.

9. The supporting device of claim 4, wherein the body plate of the claw trimming part is gently curved in an arc shape in a width direction of the body plate.
